(19) United States
(12) Patent Application Publication
(10) Pub. No.: US 2025/0348972 A1
(43) Pub. Date: Nov. 13, 2025

(54) Super Resolution Image Generation

(71) Applicant: International Business Machines Corporation, Armonk, NY (US)

(72) Inventors: Wang ZHOU, White Plains, NY (US); Levente KLEIN, Tuckahoe, NY (US); Siyuan LU, San Mateo, CA (US)

(21) Appl. No.: 18/504,356

(22) Filed: Nov. 8, 2023

(51) Int. Cl. G06T 3/4053; G06T 3/4046

(52) U.S. Cl. CPC G06T 3/4053; G06T 3/4046

(57) ABSTRACT

In an approach to generating super resolution images, a computer selects a latent vector associated with a high resolution image from a plurality of latent vectors of a generative neural network model. A computer generates a super resolution image from the selected latent vector. A computer downscales the super resolution image to match a size of a plurality of low resolution images. A computer computes a difference between the super resolution image and each of the plurality of low resolution images. A computer determines a minimum difference of the difference between the super resolution image and each of the plurality of low resolution images. A computer determines the minimum difference meets a stopping criteria. A computer transmits the super resolution image to a user. A computer stores the super resolution image.

### BACKGROUND OF THE INVENTION

The present invention relates generally to the field of generative artificial intelligence, and more particularly to generating super resolution images.

Currently, many industries are trending toward cognitive models enabled by big data platforms and machine learning models. Cognitive models, also referred to as cognitive entities, are designed to remember the past, interact with humans, continuously learn, and continuously refine responses for the future with increasing levels of prediction. Machine learning explores the study and construction of algorithms that can learn from and make predictions on data. Such algorithms operate by building a model from example inputs in order to make data-driven predictions or decisions expressed as outputs, rather than following strictly static program instructions. Within the field of data analytics, machine learning is a method used to devise complex models and algorithms that lend themselves to prediction. These analytical models allow researchers, data scientists, engineers, and analysts to produce reliable, repeatable decisions and results and to uncover hidden insights through learning from historical relationships and trends in the data.

Generative artificial intelligence (also generative AI or GenAI) is artificial intelligence capable of generating text, images, or other media, using generative models. Generative AI models learn the patterns and structure of their input training data and then generate new data that has similar characteristics. Generative AI has uses across a wide range of industries, including art, writing, software development, product design, healthcare, finance, gaming, marketing, and fashion.

Latent space is a representation of compressed data in which similar data points are closer together in space. Latent space is useful for learning data features and for finding simpler representations of data for analysis. Each data point is compressed from the original input, with a typical compression factor between 10 and 20. For example, if an image is 256 pixels by 256 pixels, then the data is compressed to a vector that can have a length of 1000. The latent vector can be graphed such that features in the latent space that are similar are closer together on the graph. By analyzing data in the latent space, patterns or structural similarities between data points can be understood.

### SUMMARY

Embodiments of the present invention disclose a computer-implemented method, a computer program product, and a system for generating super resolution images. The computer-implemented method may include one or more computer processors selecting a latent vector associated with a high resolution image from a plurality of latent vectors of a generative neural network model. One or more computer processors generate a super resolution image from the selected latent vector. One or more computer processors downscale the super resolution image to match a size of a plurality of low resolution images. One or more computer processors compute a difference between the super resolution image and each of the plurality of low resolution images. One or more computer processors determine a minimum difference of the difference between the super resolution image and each of the plurality of low resolution images. One or more computer processors determine the minimum difference meets a stopping criteria. One or more computer processors transmit the super resolution image to a user. One or more computer processors store the super resolution image.

### BRIEF DESCRIPTION OF THE DRAWINGS

FIG. 1 is a functional block diagram illustrating a distributed data processing environment, in accordance with an embodiment of the present invention;

FIG. 2 is a flowchart depicting operational steps of a super resolution image program, on a server computer within the distributed data processing environment of FIG. 1, for generating super resolution images, in accordance with an embodiment of the present invention; and

FIG. 3 illustrates an exemplary computer environment in which aspects of one or more of the illustrative embodiments may be implemented, and at least some of the computer code involved in performing the inventive methods may be executed, in accordance with an embodiment of the present invention.

### DETAILED DESCRIPTION

Super resolution (SR) of images, i.e., synthesizing high resolution (HR) images from a low resolution (LR) input, is a concern because there are known solutions that can lead to the same LR image. Some existing SR methods typically model the mapping from LR to HR with a neural network that minimizes the pixelwise difference between the SR output and the HR ground-truth, which can result in many possible images corresponding to the same LR image. The approach also requires creating the LR image artificially by downscaling the HR image at a pre-defined ratio, for example, a power of two. Using natural image priors learned by generative adversarial networks (GANs) can improve the sharpness of the generated images, however the method can generate many HR images that are all acceptable by similarity criteria. Embodiments of the present invention recognize that improvement to the process of generating super resolution images can be made by providing a system that can super resolve satellite images at an arbitrary scale where the latent space is filtered by physical constraints to reduce the overall possible number of HR images. Embodiments of the present invention recognize that improvement to the process of generating super resolution images can also be made by anchoring the SR image to multiple LR images of the same area. Implementation of embodiments of the invention may take a variety of forms, and exemplary implementation details are discussed subsequently with reference to the Figures.

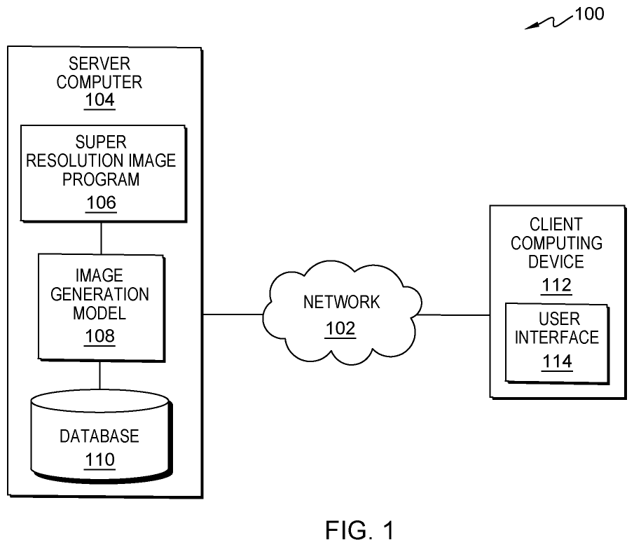

FIG. 1 is a functional block diagram illustrating a distributed data processing environment, generally designated 100, in accordance with one embodiment of the present invention. The term “distributed” as used herein describes a computer system that includes multiple, physically distinct devices that operate together as a single computer system. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

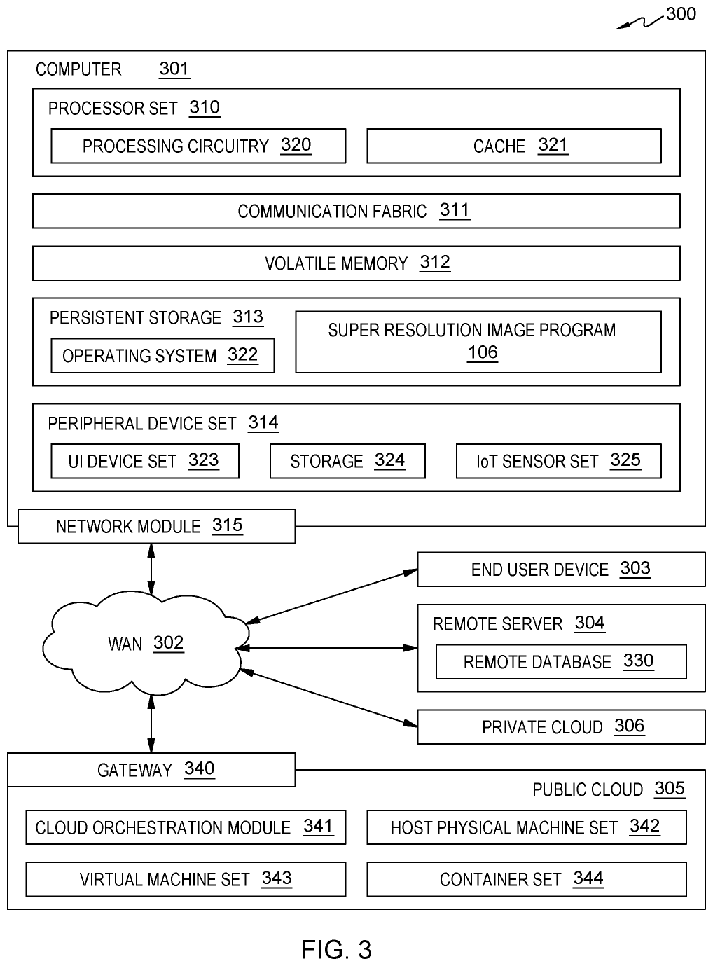

Distributed data processing environment 100 includes server computer 104 and client computing device 112, interconnected over network 102. Network 102 can be, for example, a telecommunications network, a local area network (LAN), a wide area network (WAN), such as the Internet, or a combination of the three, and can include wired, wireless, or fiber optic connections. Network 102 can include one or more wired and/or wireless networks capable of receiving and transmitting data, voice, and/or video signals, including multimedia signals that include voice, data, and video information. In general, network 102 can be any combination of connections and protocols that will support communications between server computer 104, client computing device 112, and other computing devices (not shown) within distributed data processing environment 100. Distributed data processing environment 100 may be implemented in computing environment 300 shown in FIG. 3.

Server computer 104 can be a standalone computing device, a management server, a web server, a mobile computing device, or any other electronic device or computing system capable of receiving, sending, and processing data. In other embodiments, server computer 104 can represent a server computing system utilizing multiple computers as a server system, such as in a cloud computing environment. In another embodiment, server computer 104 can be a laptop computer, a tablet computer, a netbook computer, a personal computer (PC), a desktop computer, a personal digital assistant (PDA), a smart phone, an edge device, a containerized workload, or any programmable electronic device capable of communicating with client computing device 112 and other computing devices (not shown) within distributed data processing environment 100 via network 102. In another embodiment, server computer 104 represents a computing system utilizing clustered computers and components (e.g., database server computers, application server computers, etc.) that act as a single pool of seamless resources when accessed within distributed data processing environment 100. Server computer 104 includes super resolution image program 106, image generation model 108, and database 110. Server computer 104 may include internal and external hardware components, as depicted and described in further detail with respect to computer 301 of FIG. 3.

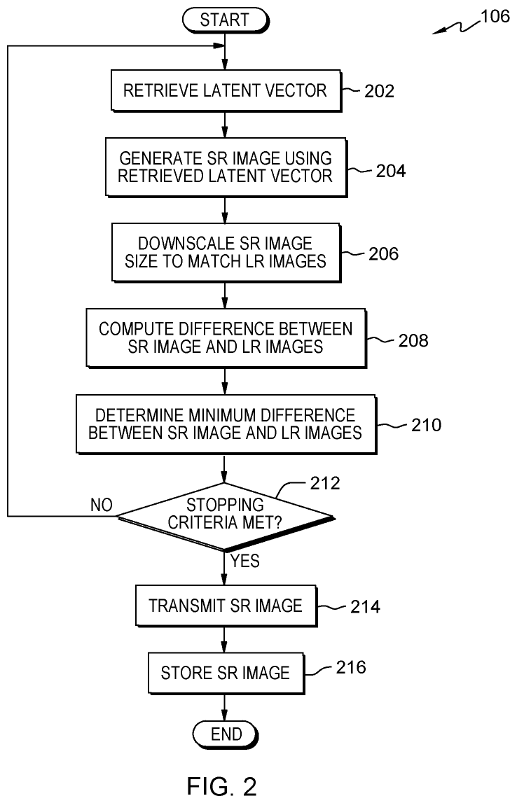

Super resolution image program 106 is a system that generates a SR image from a random latent vector then downscales the SR image to match the resolution of LR images from the same or similar location in order to confirm that the SR image conforms to imposed physical constraints. Super resolution image program 106 retrieves a latent vector from image generation model 108. Super resolution image program 106 generates a SR image using the retrieved latent vector. Super resolution image program 106 downscales the size of the SR image to match associated LR images. Super resolution image program 106 computes the difference between the SR image and the LR images. Super resolution image program 106 determines the minimum difference between the SR image and the LR images. Super resolution image program 106 determines whether a stopping criteria is met, and, if not, then super resolution image program 106 retrieves another latent vector. If super resolution image program 106 determines the stopping criteria is met, then super resolution image program 106 transmits the SR image to the user and stores the image in database 110. Super resolution image program 106 is depicted and described in further detail with respect to FIG. 2.

Image generation model 108 is a generative neural network model for generating high resolution (HR) images as a natural image prior. Image generation model 108 is trained to generate a HR image from a medium resolution image, where for every input satellite image sample, image generation model 108 can output multiple images, each associated with a latent vector. In an embodiment, image generation model 108 can have millions of latent vectors. In an embodiment, the latent vectors meet imposed constraints to ensure the images are physically realistic. For example, if the latent vector of an image of an area that includes several buildings does not include data associated with the buildings, then image generation model 108 does not use that latent vector. Image generation model 108 is trained by collecting sample data of HR satellite images, then instructing image generation model 108 to generate realistic images that follow the distribution of the HR images from random latent vectors. During training of image generation model 108, a well-defined set of rules based on physical knowledge is enforced. An example of a rule based on physical knowledge may be a temporal component, such as a multiple timestamp consistency. For example, time deepened variations in nature are known, such as exhibited by images of a tree over time. It is expected that a tree, in the Northern Hemisphere, has no leaves in January, February, or March, but will have leaves from April through October, then no leaves again in November and December. If there are five images of a specific tree generated at different moments in time, and image generation model 108 outputs an image of green tree in December, then the image is not sorted in the right order because a tree with leaves is expected to occur in the April through October timeframe. If image generation model 108 insists the image is correct, then image generation model 108 is penalized. Another example of a rule based on physical knowledge is overlapping consistency. For example, images of locations or areas with coordinates that overlap must have the same attributes, such as color, texture, and/or spatial variations. Training concludes when a comparison of a coarser generated image to a coarser reference image determines the images match. In an embodiment, image generation model 108 can be newly trained from provided sample images. In another embodiment, image generation model 108 can be a pretrained model.

In the depicted embodiment, database 110 resides on server computer 104. In another embodiment, database 110 may reside elsewhere within distributed data processing environment 100, provided that super resolution image program 106 has access to database 110, via network 102. A database is an organized collection of data. Database 110 can be implemented with any type of storage device capable of storing data and configuration files that can be accessed and utilized by super resolution image program 106 such as a database server, a hard disk drive, or a flash memory. Database 110 stores information used by and generated by super resolution image program 106. For example, database 110 stores the SR images generated by super resolution image program 106. Database 110 also stores a plurality of low resolution (LR) images for comparison to the generated SR image. LR images may be captured using one or more of satellite, aerial, drone images, or photography. Database 110 may also store a plurality of high resolution (HR) images for training image generation model 108. Database 110 also stores one or more stopping criteria for use by super resolution image program 106 and/or image generation model 108.

The present invention may contain various accessible data sources, such as database 110, that may include personal data, content, or information the user wishes not to be processed. Personal data includes personally identifying information or sensitive personal information as well as user information, such as tracking or geolocation information. Processing refers to any operation, automated or unautomated, or set of operations such as collecting, recording, organizing, structuring, storing, adapting, altering, retrieving, consulting, using, disclosing by transmission, dissemination, or otherwise making available, combining, restricting, erasing, or destroying personal data. Super resolution image program 106 enables the authorized and secure processing of personal data. Super resolution image program 106 provides informed consent, with notice of the collection of personal data, allowing the user to opt in or opt out of processing personal data. Consent can take several forms. Opt-in consent can impose on the user to take an affirmative action before personal data is processed. Alternatively, opt-out consent can impose on the user to take an affirmative action to prevent the processing of personal data before personal data is processed. Super resolution image program 106 provides information regarding personal data and the nature (e.g., type, scope, purpose, duration, etc.) of the processing. Super resolution image program 106 provides the user with copies of stored personal data. Super resolution image program 106 allows the correction or completion of incorrect or incomplete personal data. Super resolution image program 106 allows the immediate deletion of personal data.

Client computing device 112 can be one or more of a laptop computer, a tablet computer, a smart phone, smart watch, a smart speaker, or any programmable electronic device capable of communicating with various components and devices within distributed data processing environment 100, via network 102. Client computing device 112 may be a wearable computer. Wearable computers are miniature electronic devices that may be worn by the bearer under, with, or on top of clothing, as well as in or connected to glasses, hats, or other accessories. Wearable computers are especially useful for applications that require more complex computational support than merely hardware coded logics. In one embodiment, the wearable computer may be in the form of a head mounted display. The head mounted display may take the form-factor of a pair of glasses. In an embodiment, the wearable computer may be in the form of a smart watch or a smart tattoo. In an embodiment, client computing device 112 may be integrated into a vehicle. For example, client computing device 112 may be a heads-up display in the windshield of the vehicle. In an embodiment where client computing device 112 is integrated into the vehicle, client computing device 112 includes a programmable, embedded Subscriber Identity Module (eSIM) card (not shown) that includes a unique identifier of the vehicle in addition to other vehicle information. In general, client computing device 112 represents one or more programmable electronic devices or combination of programmable electronic devices capable of executing machine readable program instructions and communicating with other computing devices (not shown) within distributed data processing environment 100 via a network, such as network 102. Client computing device 112 includes an instance of user interface 114.

User interface 114 provides an interface between super resolution image program 106 on server computer 104 and a user of client computing device 112. In one embodiment, user interface 114 is mobile application software. Mobile application software, or an “app,” is a computer program designed to run on smart phones, tablet computers and other mobile devices. In one embodiment, user interface 114 may be a graphical user interface (GUI) or a web user interface (WUI) and can display text, documents, web browser windows, user options, application interfaces, and instructions for operation, and include the information (such as graphic, text, and sound) that a program presents to a user and the control sequences the user employs to control the program. In an embodiment, user interface 114 enables a user of client computing device 112 to provide input images, such as LR images, for super resolution image program 106 and/or image generation model 108, to be stored in database 110. User interface 114 also enables a user of client computing device 112 to receive SR images generated by super resolution image program 106.

FIG. 2 is a flowchart depicting operational steps of super resolution image program 106, on server computer 104 within distributed data processing environment 100 of FIG. 1, for generating super resolution images, in accordance with an embodiment of the present invention.

Super resolution image program 106 retrieves a latent vector (step 202). In an embodiment, super resolution image program 106 samples the latent vectors of image generation model 108 and randomly chooses one of the available latent vectors. In an embodiment where image generation model 108 stores latent vectors in database 110, super resolution image program 106 retrieves the latent vector from database 110.

Super resolution image program 106 generates a SR image using the retrieved latent vector (step 204). In an embodiment, based on the retrieved latent vector, super resolution image program 106 generates a SR image. In an embodiment, super resolution image program 106 instructs image generation model 108 to generate the SR image based on the retrieved latent vector.

Super resolution image program 106 downscales the size of the SR image to match associated LR images (step 206). In an embodiment, super resolution image program 106 retrieves a plurality of LR images associated with the SR image (i.e., the selected latent vector) from database 110 and determines the size of the LR images. In another embodiment, super resolution image program 106 receives the LR images from the user of client computing device 112, via user interface 114. As used herein, the term size may indicate a number of pixels, a spatial resolution, a physical size, etc. For example, a size of an image can be four by four pixels or four million by four million pixels. Size can vary based on the feature to resolve and the resolution of the image. For example, for a 1-meter resolution image, to resolve a tree, where the tree canopy is 4 to 5 meters, five by five pixels is required. In an embodiment, super resolution image program 106 downscales the size of the SR image to match the size of the LR images, thus anchoring the SR image to the LR images. For example, super resolution image program 106 reduces the resolution, i.e., the number of pixels, of the SR image to match the resolution of the LR images.

Super resolution image program 106 computes the difference between the SR image and the LR images (step 208). In an embodiment, super resolution image program 106 compares the downscaled SR image with each of the LR images to determine the difference between the SR image and the LR images. For example, the difference may be a difference in clarity. In another example, the difference may be in spatial resolution, i.e., the number of pixels. In yet another example, the difference may be in color value. In an embodiment, super resolution image program 106 calculates the difference as the root mean square difference between pixels calculated for each spectral channel. In another embodiment, super resolution image program 106 calculates the difference using a self-similarity index, as would be recognized by a person of skill in the art. In another embodiment, super resolution image program 106 computes the difference by a comparison of color consistency for multiple LR images that have overlapping areas, where it is expected that the images capture the same features on the ground. In yet another embodiment, super resolution image program 106 computes the difference using a time series evolution of the images, where gradual, consistent change of spectral information is expected, such as the changes in the leaves of a tree over the seasons. In a further embodiment, super resolution image program 106 computes the difference by determining geometric changes, such as a consistent size of features across multiple images. For example, super resolution image program 106 may detect a ball in an image and expect the SR image to maintain the same size ratio of the ball as compared to a chair in the image. In an embodiment, super resolution image program 106 can use a rule such as multiple timestamp consistency or overlapping consistency to check the consistency between one or multiple images and the difference is expressed as a mean square error.

Super resolution image program 106 determines the minimum difference between the SR image and the LR images (step 210). In an embodiment, super resolution image program 106 compares the difference determined between the SR image and each of the LR images and identifies the minimum difference value. In an embodiment, super resolution image program 106 calculates the minimum difference using a threshold. For example, super resolution image program 106 can use one or more techniques such as a root mean square error (RMSE), a mean square error (MSE), and/or a peak signal to noise ratio (PSNR) calculation between pixels of two images, as would be recognized by a person of skill in the art. Then all images where the RMSE/MSE/PSNR is not exceeding one or multiple standard deviation can be set as a threshold. In another example, super resolution image program 106 can use one or more techniques such as structured similarity indexing method (SSIM) and/or feature similarity indexing method (FSIM) to compare the structural and feature similarity measures between two images, as would be recognized by a person of skill in the art, and, again use a threshold that can be a number related to one standard deviation.

Super resolution image program 106 determines whether a stopping criteria is met (decision block 212). In an embodiment, super resolution image program 106 compares the minimum difference value to the stopping criteria provided by the user and determines whether the difference is less than or equal to the criteria. In an embodiment, super resolution image program 106 determines whether an average difference value between the SR image and the LR images meets the stopping criteria. In another embodiment, super resolution image program 106 determines whether a percentage of the difference values between the SR image and the LR images meets the stopping criteria. In an embodiment, super resolution image program 106 can use the multiple timestamp consistency or overlapping consistency as a stopping criteria.

If super resolution image program 106 determines the stopping criteria is not met (“no” branch, decision block 212), then super resolution image program 106 returns to step 202 to retrieve another latent vector. In an embodiment, if the difference exceeds the stopping criteria, then super resolution image program 106 iteratively repeats the process until the difference meets the stopping criteria, i.e., the generated SR image sufficiently matches the LR image.

If super resolution image program 106 determines the stopping criteria is met (“yes” branch, decision block 212), then super resolution image program 106 transmits the SR image to the user (step 214). In an embodiment, super resolution image program 106 transmits the SR image to the user of client computing device 112, via user interface 114. In an embodiment, super resolution image program 106 transmits the SR image via email. In another embodiment, super resolution image program 106 transmits the SR image via text message. In an embodiment, super resolution image program 106 transmits a message, via user interface 114, that includes a link to the SR image, such that when the user clicks on the link, the user can view the SR image. In an embodiment, super resolution image program 106 provides the user, via user interface 114, an opportunity to accept or reject the SR image. In the embodiment, if the user rejects the SR image, super resolution image program 106 returns to step 202 to repeat the process with a new latent vector sample.

Super resolution image program 106 stores the image (step 216). In an embodiment, super resolution image program 106 stores the SR image in database 110. In an embodiment, super resolution image program 106 stores the SR image in association with the latent vector that was selected or retrieved in step 202. In an embodiment where super resolution image program 106 provided the user the opportunity to accept or reject the SR image, super resolution image program 106 stores the received feedback from the user to add to the training data of image generation model 108 to improve future outcomes.

FIG. 3 is an example diagram of a distributed data processing environment in which aspects of one or more of the illustrative embodiments may be implemented, and at least some of the computer code involved in performing the inventive methods may be executed, in accordance with an embodiment of the present invention, in accordance with an embodiment of the present invention. It should be appreciated that FIG. 3 provides only an illustration of one implementation and does not imply any limitations with regard to the environments in which different embodiments can be implemented. Many modifications to the depicted environment can be made.

Computing environment 300 contains an example of an environment for the execution of at least some of the computer code involved in performing the inventive methods, such as super resolution image program 106 for generating super resolution images. In addition to super resolution image program 106, computing environment 300 includes, for example, computer 301, wide area network (WAN) 302, end user device (EUD) 303, remote server 304, public cloud 305, and private cloud 306. In this embodiment, computer 301 includes processor set 310 (including processing circuitry 320 and cache 321), communication fabric 311, volatile memory 312, persistent storage 313 (including operating system 322 and super resolution image program 106, as identified above), peripheral device set 314 (including user interface (UI), device set 323, storage 324, and Internet of Things (IoT) sensor set 325), and network module 315. Remote server 304 includes remote database 330. Public cloud 305 includes gateway 340, cloud orchestration module 341, host physical machine set 342, virtual machine set 343, and container set 344.

Computer 301 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 330. As is well understood in the art of computer technology, and depending upon the technology, performance of a computer-implemented method may be distributed among multiple computers and/or between multiple locations. On the other hand, in this presentation of computing environment 300, detailed discussion is focused on a single computer, specifically computer 301, to keep the presentation as simple as possible. Computer 301 may be located in a cloud, even though it is not shown in a cloud in FIG. 3. On the other hand, computer 301 is not required to be in a cloud except to any extent as may be affirmatively indicated.

Processor set 310 includes one, or more, computer processors of any type now known or to be developed in the future. Processing circuitry 320 may be distributed over multiple packages, for example, multiple, coordinated integrated circuit chips. Processing circuitry 320 may implement multiple processor threads and/or multiple processor cores. Cache 321 is memory that is located in the processor chip package(s) and is typically used for data or code that should be available for rapid access by the threads or cores running on processor set 310. Cache memories are typically organized into multiple levels depending upon relative proximity to the processing circuitry. Alternatively, some, or all, of the cache for the processor set may be located “off chip.” In some computing environments, processor set 310 may be designed for working with qubits and performing quantum computing.

Computer readable program instructions are typically loaded onto computer 301 to cause a series of operational steps to be performed by processor set 310 of computer 301 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 321 and the other storage media discussed below. The program instructions, and associated data, are accessed by processor set 310 to control and direct performance of the inventive methods. In computing environment 300, at least some of the instructions for performing the inventive methods may be stored in super resolution image program 106 in persistent storage 313.

Communication fabric 311 is the signal conduction paths that allow the various components of computer 301 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 312 is any type of volatile memory now known or to be developed in the future. Examples include dynamic type random access memory (RAM) or static type RAM. Typically, the volatile memory is characterized by random access, but this is not required unless affirmatively indicated. In computer 301, the volatile memory 312 is located in a single package and is internal to computer 301, but, alternatively or additionally, the volatile memory may be distributed over multiple packages and/or located externally with respect to computer 301.

Persistent storage 313 is any form of non-volatile storage for computers that is now known or to be developed in the future. The non-volatility of this storage means that the stored data is maintained regardless of whether power is being supplied to computer 301 and/or directly to persistent storage 313. Persistent storage 313 may be a read only memory (ROM), but typically at least a portion of the persistent storage allows writing of data, deletion of data and re-writing of data. Some familiar forms of persistent storage include magnetic disks and solid-state storage devices. Operating system 322 may take several forms, such as various known proprietary operating systems or open-source Portable Operating System Interface type operating systems that employ a kernel. The code included in super resolution image program 106 typically includes at least some of the computer code involved in performing the inventive methods.

Peripheral device set 314 includes the set of peripheral devices of computer 301. Data communication connections between the peripheral devices and the other components of computer 301 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 323 may include components such as a display screen, speaker, microphone, wearable devices (such as goggles and smart watches), keyboard, mouse, printer, touchpad, game controllers, and haptic devices. Storage 324 is external storage, such as an external hard drive, or insertable storage, such as an SD card. Storage 324 may be persistent and/or volatile. In some embodiments, storage 324 may take the form of a quantum computing storage device for storing data in the form of qubits. In embodiments where computer 301 is required to have a large amount of storage (for example, where computer 301 locally stores and manages a large database) then this storage may be provided by peripheral storage devices designed for storing very large amounts of data, such as a storage area network (SAN) that is shared by multiple, geographically distributed computers. IoT sensor set 325 is made up of sensors that can be used in Internet of Things applications. For example, one sensor may be a thermometer and another sensor may be a motion detector.

Network module 315 is the collection of computer software, hardware, and firmware that allows computer 301 to communicate with other computers through WAN 302. Network module 315 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 315 are performed on the same physical hardware device. In other embodiments (for example, embodiments that utilize software-defined networking (SDN)), the control functions and the forwarding functions of network module 315 are performed on physically separate devices, such that the control functions manage several different network hardware devices. Computer readable program instructions for performing the inventive methods can typically be downloaded to computer 301 from an external computer or external storage device through a network adapter card or network interface included in network module 315.

WAN 302 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 303 is any computer system that is used and controlled by an end user (for example, a customer of an enterprise that operates computer 301) and may take any of the forms discussed above in connection with computer 301. EUD 303 typically receives helpful and useful data from the operations of computer 301. For example, in a hypothetical case where computer 301 is designed to provide a recommendation to an end user, this recommendation would typically be communicated from network module 315 of computer 301 through WAN 302 to EUD 303. In this way, EUD 303 can display, or otherwise present, the recommendation to an end user. In some embodiments, EUD 303 may be a client device, such as thin client, heavy client, mainframe computer, desktop computer and so on.

Remote server 304 is any computer system that serves at least some data and/or functionality to computer 301. Remote server 304 may be controlled and used by the same entity that operates computer 301. Remote server 304 represents the machine(s) that collect and store helpful and useful data for use by other computers, such as computer 301. For example, in a hypothetical case where computer 301 is designed and programmed to provide a recommendation based on historical data, then this historical data may be provided to computer 301 from remote database 330 of remote server 304.

Public cloud 305 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 305 is performed by the computer hardware and/or software of cloud orchestration module 341. The computing resources provided by public cloud 305 are typically implemented by virtual computing environments that run on various computers making up the computers of host physical machine set 342, which is the universe of physical computers in and/or available to public cloud 305. The virtual computing environments (VCEs) typically take the form of virtual machines from virtual machine set 343 and/or containers from container set 344. It is understood that these VCEs may be stored as images and may be transferred among and between the various physical machine hosts, either as images or after instantiation of the VCE. Cloud orchestration module 341 manages the transfer and storage of images, deploys new instantiations of VCEs and manages active instantiations of VCE deployments. Gateway 340 is the collection of computer software, hardware, and firmware that allows public cloud 305 to communicate through WAN 302.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 306 is similar to public cloud 305, except that the computing resources are only available for use by a single enterprise. While private cloud 306 is depicted as being in communication with WAN 302, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 305 and private cloud 306 are both part of a larger hybrid cloud.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The foregoing descriptions of the various embodiments of the present invention have been presented for purposes of illustration and example but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method comprising:
selecting, by one or more computer processors, a latent vector associated with a high resolution image from a plurality of latent vectors of a generative neural network model;
generating, by one or more computer processors, a super resolution image from the selected latent vector;
downscaling, by one or more computer processors, the super resolution image to match a size of a plurality of low resolution images;
computing, by one or more computer processors, a difference between the super resolution image and each of the plurality of low resolution images;
determining, by one or more computer processors, a minimum difference of the difference between the super resolution image and each of the plurality of low resolution images;
determining, by one or more computer processors, the minimum difference meets a stopping criteria;
transmitting, by one or more computer processors, the super resolution image to a user; and
storing, by one or more computer processors, the super resolution image.

2. The computer-implemented method of claim 1, wherein the generative neural network model is trained using a set of rules based on physical knowledge, and wherein the rules include at least one of a multiple timestamp consistency and an overlapping consistency.

3. The computer-implemented method of claim 1, further comprising:
retrieving, by one or more computer processors, the plurality of low resolution images; and
determining, by one or more computer processors, the size of each of the plurality of low resolution images.

4. The computer-implemented method of claim 1, wherein the size of an image is selected from the group consisting of: a number of pixels, a spatial resolution, and a physical size.

5. The computer-implemented method of claim 1, wherein the difference between the super resolution image and each of the plurality of low resolution images includes at least one of an average difference between the super resolution image and the plurality of low resolution images meets the stopping criteria and a percentage of difference values between the super resolution image and the plurality of low resolution images meets the stopping criteria.

6. The computer-implemented method of claim 1, further comprising:
responsive to transmitting the super resolution image to the user, providing, by one or more computer processors, an opportunity to the user to accept the super resolution image via a user interface.

7. The computer-implemented method of claim 1, wherein downscaling the super resolution image to match the size of the plurality of low resolution images further comprises:
reducing, by one or more computer processors, a number of pixels associated with the super resolution image to match a number of pixels associated with the plurality of low resolution images.

8. A computer program product comprising:
one or more computer readable storage media;
program instructions, stored on at least one of the one or more computer readable storage media, to select a latent vector associated with a high resolution image from a plurality of latent vectors of a generative neural network model;
program instructions, stored on at least one of the one or more computer readable storage media, to generate a super resolution image from the selected latent vector;
program instructions, stored on at least one of the one or more computer readable storage media, to downscale the super resolution image to match a size of a plurality of low resolution images;
program instructions, stored on at least one of the one or more computer readable storage media, to compute a difference between the super resolution image and each of the plurality of low resolution images;
program instructions, stored on at least one of the one or more computer readable storage media, to determine a minimum difference of the difference between the super resolution image and each of the plurality of low resolution images;
program instructions, stored on at least one of the one or more computer readable storage media, to determine the minimum difference meets a stopping criteria;
program instructions, stored on at least one of the one or more computer readable storage media, to transmit the super resolution image to a user; and
program instructions, stored on at least one of the one or more computer readable storage media, to store the super resolution image.

9. The computer program product of claim 8, wherein the generative neural network model is trained using a set of rules based on physical knowledge, and wherein the rules include at least one of a multiple timestamp consistency and an overlapping consistency.

10. The computer program product of claim 8, further comprising:
program instructions, stored on at least one of the one or more computer readable storage media, to retrieve the plurality of low resolution images; and
program instructions, stored on at least one of the one or more computer readable storage media, to determine the size of each of the plurality of low resolution images.

11. The computer program product of claim 8, wherein the size of an image is selected from the group consisting of: a number of pixels, a spatial resolution, and a physical size.

12. The computer program product of claim 8, wherein the difference between the super resolution image and each of the plurality of low resolution images includes at least one of an average difference between the super resolution image and the plurality of low resolution images meets the stopping criteria and a percentage of difference values between the super resolution image and the plurality of low resolution images meets the stopping criteria.

13. The computer program product of claim 8, further comprising:
responsive to transmitting the super resolution image to the user, program instructions, stored on at least one of the one or more computer readable storage media, to provide an opportunity to the user to accept the super resolution image via a user interface.

14. The computer program product of claim 8, wherein downscaling the super resolution image to match the size of the plurality of low resolution images further comprises:
program instructions, stored on at least one of the one or more computer readable storage media, to reduce a number of pixels associated with the super resolution image to match a number of pixels associated with the plurality of low resolution images.

15. A computer system comprising:
one or more computer processors;
one or more computer readable memories; and
one or more computer readable storage media;
program instructions, stored on at least one of the one or more computer readable storage media for execution by at least one of the one or more computer processors via at least one of the one or more memories, to select a latent vector associated with a high resolution image from a plurality of latent vectors of a generative neural network model;
program instructions, stored on at least one of the one or more computer readable storage media for execution by at least one of the one or more computer processors via at least one of the one or more memories, to generate a super resolution image from the selected latent vector;
program instructions, stored on at least one of the one or more computer readable storage media for execution by at least one of the one or more computer processors via at least one of the one or more memories, to downscale the super resolution image to match a size of a plurality of low resolution images;
program instructions, stored on at least one of the one or more computer readable storage media for execution by at least one of the one or more computer processors via at least one of the one or more memories, to compute a difference between the super resolution image and each of the plurality of low resolution images;
program instructions, stored on at least one of the one or more computer readable storage media for execution by at least one of the one or more computer processors via at least one of the one or more memories, to determine a minimum difference of the difference between the super resolution image and each of the plurality of low resolution images;
program instructions, stored on at least one of the one or more computer readable storage media for execution by at least one of the one or more computer processors via at least one of the one or more memories, to determine the minimum difference meets a stopping criteria;
program instructions, stored on at least one of the one or more computer readable storage media for execution by at least one of the one or more computer processors via at least one of the one or more memories, to transmit the super resolution image to a user; and
program instructions, stored on at least one of the one or more computer readable storage media for execution by at least one of the one or more computer processors via at least one of the one or more memories, to store the super resolution image.

16. The computer system of claim 15, wherein the generative neural network model is trained using a set of rules based on physical knowledge, and wherein the rules include at least one of a multiple timestamp consistency and an overlapping consistency.

17. The computer system of claim 15, further comprising:
program instructions, stored on at least one of the one or more computer readable storage media for execution by at least one of the one or more computer processors via at least one of the one or more memories, to retrieve the plurality of low resolution images; and
program instructions, stored on at least one of the one or more computer readable storage media for execution by at least one of the one or more computer processors via at least one of the one or more memories, to determine the size of each of the plurality of low resolution images.

18. The computer system of claim 15, wherein the size of an image is selected from the group consisting of: a number of pixels, a spatial resolution, and a physical size.

19. The computer system of claim 15, wherein the difference between the super resolution image and each of the plurality of low resolution images includes at least one of an average difference between the super resolution image and the plurality of low resolution images meets the stopping criteria and a percentage of difference values between the super resolution image and the plurality of low resolution images meets the stopping criteria.

20. The computer system of claim 15, wherein downscaling the super resolution image to match the size of the plurality of low resolution images further comprises:
program instructions, stored on at least one of the one or more computer readable storage media for execution by at least one of the one or more computer processors via at least one of the one or more memories, to reduce a number of pixels associated with the super resolution image to match a number of pixels associated with the plurality of low resolution images.
